(19) United States
(12) Patent Application Publication
(10) Pub. No.: US 2019/0300757 A1
(43) Pub. Date: Oct. 3, 2019

(54) TILES BACKED WITH PATTERNS OF PRESSURE SENSITIVE ADHESIVE

(71) Applicant: ENGINEERED FLOORS LLC, Dalton, GA (US)

(72) Inventors: John Joseph Matthews REES, Chattanooga, TN (US); Anthony DANIELL, Dalton, GA (US); Stephen TSIARKEZOS, Elkton, MD (US); Dimitri ZAFIROGLU, Centreville, DE (US)

(21) Appl. No.: 16/366,102

(22) Filed: Mar. 27, 2019

Related U.S. Application Data
(60) Provisional application No. 62/648,627, filed on Mar. 27, 2018.

(51) Int. Cl. C09J 7/38; E04F 13/08; E04F 15/02; C09J 5/00

(52) U.S. Cl. CPC C09J 7/385; E04F 13/0887; C09J 2433/00; C09J 5/00; C09J 2400/266; E04F 15/02155

(57) ABSTRACT

A surface covering tile has a plurality of edges extending between the face and the back surface. A pressure sensitive adhesive is disposed on the back surface and covers less than 40% of the back along each one of the plurality of edges where the back surface intersects the plurality of edges. For highly porous back surfaces, the pressure sensitive adhesive is selected and applied in a manner limiting penetration into the back surface. The amount of pressure sensitive adhesive required to affix the tile is reduced, and the tile can be optionally constructed in a manner that facilitates lateral movement of the tile during installation.

### CROSS REFERENCE TO RELATED APPLICATIONS

The present application claims priority to U.S. Provisional Patent Application No. 62/648,627, filed Mar. 27, 2018, the entire contents of which are incorporated herein by reference.

### TECHNICAL FIELD

Embodiments of the subject matter disclosed herein relate to wall and floor tile coverings backed with pressure sensitive adhesive.

### BACKGROUND

Coverings for walls, floors and similar surfaces are configured as tiles. These tiles are secured to the surface to be covered using an adhesive such as a pressure-sensitive adhesive (PSA). The PSA is applied to the back of the tile, i.e., the side placed against the surface to be covered, and is initially covered with a non-sticking release-sheet for storage and handling prior to installation. The release-sheet is removed, and the tile is placed in the desired location over the surface to be covered. Once located, the tile is secured by pressing the front or exposed face of the tile toward the surface to be tiled. The recommended installation procedure rolls each installed tile with a 100 pound roller to press the adhesive fully to the surface to be tiled, e.g., the floor. In order to control adhesion to concrete floors, a special primer coating is often applied to coat the floor before adhering the tile directly to the concrete.

Conventional applications of PSA add significant weight and cost to each tile. This additional weight and cost increases when the PSA is applied to a porous back and penetrates into the back. The increase in weight becomes more severe when the tile has a porous structure such as a felt, or when the tile is equipped with a backing that is a porous and bulky felt, as the PSA needs to penetrate deeper into the felt to engage the fibers within the felt. In addition to the increase in weight and associated cost necessitated by a porous back, the cut edges of the tile are susceptible to delamination from the surface to be tiled. To prevent delamination at the cut edges, a heavy overall application of PSA to the back of the tile is typically used. A heavy overall application of PSA unnecessarily increases weight and cost as the heavy application of PSA is not required in the interior areas of the back of the tile away from the cut edges.

In addition to the undesired increase in tile weight and associated costs, adhesive, and in particular PSA, can complicate the application and removal of tiles. Once the PSA contacts the surface to be tiled, the tile cannot be easily moved along the surface to adjust or improve alignment with other tiles. In addition, when a tile is removed from the surface, residual PSA stays at least partially on the tiled surface and the back of the tile that is removed. Removal of the residual PSA from the tiled surface requires elaborate scraping or chemical cleaning. Residual PSA on the back of the tile limits the ability of the tile to be recycled unless that residual PSA is laboriously removed. A relatively heavy solid layer of PSA also limits the breathability of the tile and the capacity of the tile to allow moisture to escape from the surface through the tile.

### SUMMARY

Exemplary embodiments are directed to tiles used as surface coverings including floor coverings and wall coverings that include an application of adhesive, for example, pressure sensitive adhesive (PSA), to the back of the tile, that minimizes the amount of adhesive required to secure the tile to a desired surface, facilitates the installation process, and improves performance on the floor or wall. In one embodiment, the PSA is applied to a porous backing while avoiding easy penetration of the PSA into the porous backing that results in the use of an excessive amount of adhesive. In one embodiment, the PSA applied to the back of the tile is configured to remain on either the back of the tile or on the surface to which the tile is attached upon removal of the tile from that surface even after long term use. In one embodiment, the tile is breathable and allows moisture to pass through the tile from the back after the PSA is applied to the back of the tile. In one embodiment, the tile can be moved along the surface to be covered during installation to facilitate alignment until pressure is applied to the face of the tile to engage the PSA and affix the tile to the surface to be covered. In one embodiment, a reinforcing or stabilizing layer is attached to the back of a tile that has pressure-sensitive surfaces to simultaneously stabilize the tile and allow easy installation.

Exemplary embodiments are directed to a surface covering tile having a face, a back opposite the face and a thickness measured between the face and the back. A plurality of edges extends between the face and the back, i.e., the thickness, of the surface covering tile. Suitable surface covering tiles include, but are not limited to, floorcovering tiles. In one embodiment, the surface covering tile includes a face layer, and the face is the top or front face of the face layer. In one embodiment, either the face of the surface covering tile or face layer is a fibrous material. In one embodiment, the back of the surface covering tile that receives the PSA is the back face of the face layer. In one embodiment, the face is the exposed top surface of a face layer, and the back receiving the PSA is the contact surface of an added backing or back layer. In one embodiment, the back is a porous surface. In one embodiment, the back is a flattened, pre-calendered surface. In one embodiment, the back is a surface of a backing or back layer that is a porous fibrous felt with fiber tufts and fiber ends projecting from the surface. In one embodiment, the surface covering tile contains one or more intermediate layers disposed between a face layer and a backing layer.

An adhesive, and preferably a pressure sensitive adhesive, is disposed on the back. In one embodiment, the pressure sensitive adhesive covers less than 40% of the back along each one of the plurality of edges, i.e., the back cut edges, where the back intersects the plurality of edges. In one embodiment, the pressure sensitive adhesive covers less than 25% of the entire surface area of the back. In one embodiment, the pressure sensitive adhesive extends along the back to the plurality of edges at a plurality of discrete points. In one embodiment, the distance between any two points in the plurality of discrete points along the back cut edges is less than twice the thickness of the tile, preferably less than about 1.5 times the thickness of the tile. In one embodiment, the pressure sensitive adhesive has a thickness of between about 0.001 inches and about 0.1 inches. In one embodiment, the pressure sensitive adhesive is applied along the surface of the back in elongated areas or lines, and the width of the areas or lines covered with PSA is approximately 0.06 inches.

Stronger adhesion to the floor results when the adhesive stays, mounds or beads up on the surface to which it is applied, e.g., the felt surface. Therefore, a sufficient amount of adhesive is accessible to fully stick to the floor. If the adhesive absorbs into the fibrous structure for example of the felt, much of the adhesive is embedded in the felt and not available to bond to the floor. In one embodiment, to reduce the amount of adhesive being absorbed into a nonwoven backing such as a felt backing, the back or exposed surface of the nonwoven backing is glazed or fused. Suitable methods for glazing or fusing the exposed surface of a nonwoven backing include, but are not limited to, singeing using infrared heating, singeing with flame treatment, and calendering with a hot calender surface to melt, glaze or fuse the exposed surface and reduce its porosity. Glazing or fusing reduces the amount of adhesive migrating into the nonwoven backing. In one embodiment, at least one of temperature and total mass of the adhesive being applied are modified to affect absorption.

In one embodiment, pressure sensitive adhesive is applied as a pressure sensitive adhesive coating. Suitable pressure sensitive adhesive coatings include, but are not limited to, a sprayed coating, a printed coating, a coating applied with contacting nozzles, a coating applied by using extrusion slot-dies, and a coasting transferred to the back of a tile using transfer rolls that receive the coating of pressure sensitive adhesive. In one embodiment, the tile also includes a release sheet attached to and covering the pressure sensitive adhesive. The release sheet can cover the entire back or just the areas of the back containing the pressure sensitive adhesive. In one embodiment the PSA is applied to a release sheet, and the PSA is transferred from the release sheet to the back of the surface covering tile by pressing the loaded release sheet onto the surface covering tile. Adhesive is then transferred from the coated release sheet to the back of the tile. Suitable release sheets are known and available in the art.

In one embodiment, the pressure sensitive adhesive forms a pre-determined pattern on the back. Suitable patterns include regular patterns and random patterns. In one embodiment, the pattern includes a plurality of curvilinear lines. In another embodiment, the pattern is a plurality of rectilinear intersecting lines. In another embodiment, the pattern is a plurality of discrete areas of pressure sensitive adhesive. The discreate areas in the plurality of discrete areas are separated from each other, and the back contains pressure sensitive adhesive only in the discrete areas. In one embodiment, the back includes adhesive areas containing the pressure sensitive adhesive and bare areas separate from the adhesive areas. In one embodiment, the surface covering tile has a first thickness in the adhesive areas and a second thickness in the bare areas. The second thickness is greater than the first thickness. In one embodiment, the back surface of the surface covering tile is compressible in the bare areas under pressure applied to the front, back or front and back of the surface covering tile.

In one embodiment, the surface covering tile includes a scrim attached to the back of the surface covering tile. The pressure sensitive adhesive is first applied to the scrim, and the scrim containing the pressure sensitive adhesive is then applied to the back of the surface covering tile. In addition to having discrete adhesive areas and bare areas on the back, the coverage density of the pressure sensitive adhesive can be varied across the back. In one embodiment, the pressure sensitive adhesive is applied with a first coverage density of pressure sensitive adhesive on the back at locations adjacent the plurality of edges, i.e., the back cut edges, and a second coverage density of pressure sensitive adhesive on the back on areas not adjacent the back cut edges. In one embodiment, the second coverage density is less than the first coverage density. Therefore, the amount or coverage density of the pressure sensitive adhesive is greater along the back cut edges.

In one embodiment, the back is a porous surface and the pressure sensitive adhesive is a material that is applied to the back at a high temperature and cooled rapidly. For example, the pressure sensitive adhesive is a material applied at a temperature from about 270° F. to about 370° F. and having a viscosity range of from about 8,000 centipoise to about 13,000 centipoise at 350° F. Suitable materials for the pressure sensitive adhesive include, but are not limited to, amorphous polyalphaolefin acrylic. In one embodiment, the polyalphaolefin PSA coating is applied across the back porous surface with minimum penetration. The polyalphaolefin PSA coating is applied at a low weight and high temperature followed by rapid cooling.

Rapid cooling reduces the absorption into the porous surface, for example of the felt, caused by the initially low viscosity of the adhesive when applied hot. Cooling quickly increases the viscosity of the hot melt PSA adhesive, allowing most of the mass of the adhesive layer to remain on top of the backing surface.

In one embodiment, the surface covering tile is a needle-punched felt. Alternatively, the surface covering tile includes a separate face layer attached to a felt. The PSA is disposed on the needle-exit surface of the felt, i.e., a surface of the felt opposite the surface into which the needles are inserted. In one embodiment, the felt includes a plurality of fiber tufts extending from the back that are created by needling the felt with an additional treatment using widely spaced high-gauge needles. In one embodiment, the pressure sensitive adhesive covers the fiber tufts, and the fiber tufts extend into the pressure sensitive adhesive.

Exemplary embodiments are also directed to a method for creating a surface covering tile. In one embodiment a face layer is attached to a backing. The exposed back of the backing is the contact surface that is brought into contact with the surface to be covered. In one embodiment, the back has a porous, highly compressible and recoverably compressible surface. Pressure sensitive adhesive is applied to the highly compressible back surface. A release sheet is then applied to the back of the surface covering tile to cover at least the areas of the back containing the pressure sensitive adhesive. The assembled surface covering tile and release sheet are compressed until the portions of the back containing the pressure sensitive adhesive and the areas outside the portion of the back containing the pressure sensitive adhesive have a common thickness. Upon removal of the release sheet and before installation of the surface covering tile, areas of the back that are free of adhesive expand to an increased thickness and protrude beyond the areas covered with adhesive. Therefore, when the surface covering tile is placed against a surface to be tiled, the expanded areas that are free of adhesive contact the surface to be tiled, and the portions of the back containing the pressure sensitive adhesive are spaced from the surface to be tile. This facilitates unobstructed lateral adjustment to achieve perfect alignment with the edges of neighboring tiles during installation while the tile rides on the projecting areas free of PSA. When pressure is subsequently applied to the face of the surface covering tile, the projecting areas that are free of adhesive are compressed, and the areas containing the PSA adhesive are brought into contact with, for example, the floor, thereby affixing the installed surface covering tile onto the floor.

In one embodiment, the pressure sensitive adhesive is applied to a partially open scrim in accordance with a desired pattern. The partially open scrim containing the pressure sensitive adhesive is applied to the back of the surface covering tile while applying the release sheet over the pressure sensitive adhesive and compressing the surface covering tile. In one embodiment, a plurality of nozzles are pressed into the highly and recoverably compressible back surface, and the pressure sensitive adhesive is injected into the backing simultaneously through the plurality of nozzles. In one embodiment the PSA is applied to a release sheet in accordance with a desired pattern. The release sheet containing the PSA is pressed onto the back of the surface covering tile such that the PSA contacts the back.

Exemplary embodiments are directed to a surface covering tile having a face, a back opposite the face, a plurality of edges extending between the face and the back and a pressure sensitive adhesive disposed on the back. In one embodiment, the back is a porous surface. Each edge intersects the back along a back cut edge, and the pressure sensitive adhesive covers less than 40% of the back along each back cut edge. In one embodiment, the tile has a thickness between the face and the back, and each edge spans the thickness. The pressure sensitive adhesive extends along the back to the plurality of edges at a plurality of discrete points along each back cut edge such that a distance between any two points in the plurality of discrete points along a given back cut edge is less than twice the thickness of the tile. In one embodiment, the distance between any two points in the plurality of discrete points is less than about 1.5 times the thickness of the tile.

In one embodiment, the pressure sensitive adhesive forms a pattern across the back, and the pattern includes a plurality of curvilinear lines or a plurality of rectilinear intersecting lines. In one embodiment, the pattern contains a plurality of discrete areas of pressure sensitive adhesive. The areas in the plurality of discrete areas are separate from each other, and the back contains pressure sensitive adhesive only in the discrete areas. In one embodiment, the back contains first areas containing the pressure sensitive adhesive and second areas separate from the first areas. The second areas are free of pressure sensitive adhesive. The surface covering tile has a first thickness between the face and the back in the first areas and a second thickness between the face and the back in the second areas. The second thickness is greater than the first thickness, and the surface covering tile is compressible in the second areas under pressure applied to the back and the face to decrease the second thickness.

In one embodiment, the surface covering tile includes an open scrim attached to at least a portion of the back, and the pressure sensitive adhesive is disposed on the scrim. In one embodiment, the pressure sensitive adhesive has a first coverage density at locations adjacent the plurality of back cut edges and a second coverage density of pressure sensitive adhesive at locations remote from the plurality of back cut edges. The first coverage density is greater than the second coverage density. In one embodiment, the pressure sensitive adhesive is amorphous polyalphaolefin acrylic. In one embodiment, the pressure sensitive adhesive is suitable for application to the back a temperature from about 270° F. to about 370° F. and has a viscosity range of from about 8,000 centipoise to about 13,000 centipoise at 350° F. In one embodiment, the pressure sensitive adhesive has a thickness of from about 0.001 inches to about 0.100 inches. In one embodiment, the pressure sensitive adhesive is arranged in a pattern containing a plurality of lines disposed across the back. Each line has a width of from about 0.030 inches to about 0.200 inches.

In one embodiment, at least one of a thickness of the pressure sensitive adhesive and a weight of the pressure sensitive varies across the back surface. In one embodiment, the surface covering tile includes a release sheet attached to and covering the pressure sensitive adhesive. The back has a back surface area, and in one embodiment, the pressure sensitive adhesive covers less than about 25% of the back surface area. In one embodiment, the surface covering tile is a felt. The felt has a needle-exit surface, and the back corresponds to the needle-exit surface. In one embodiment, the felt includes the back, and a plurality of fiber tufts extend from the back. The fiber tufts were created by needling the felt with widely spaced high-gauge needles. The pressure sensitive adhesive covers the fiber tufts, and the fiber tufts extend into the pressure sensitive adhesive. In one embodiment, the back has a flattened, pre-calendered surface.

Exemplary embodiments are also directed to a method for creating a surface covering tile having a porous and recoverably compressible back. A pressure sensitive adhesive is applied to only a portion of a surface area of the back. A release sheet is applied to the back, and the surface covering tile is compressed to a uniform thickness across the surface area of the back. The release sheet is removed, and the surface covering tile is allowed to expand to create a first thickness in the surface covering tile in the portion of the back containing the pressure sensitive adhesive and a second thickness in the surface covering tile outside the portion of the back containing the pressure sensitive adhesive. The second thickness is greater than the first thickness.

In one embodiment, in order to applying the pressure sensitive adhesive, the pressure sensitive adhesive is applied to a partially open scrim. The partially open scrim is applied to the back while applying the release sheet and compressing the surface covering tile. Suitable open scrims include, but are not limited to, a woven fabric, a knit fabric and a nonwoven fabric. In one embodiment, the open scrim contains one or more of aramid fibers, carbon fibers and yarns. In one embodiment, in order to apply the pressure sensitive adhesive, a plurality of nozzles is pressed into the back, and the pressure sensitive adhesive is injected onto the surface covering tile through the plurality of nozzles.

In one embodiment, a face layer is attached to a backing layer to create the surface covering tile. The face layer is a fibrous layer, a non-fibrous layer, a solid layer or a porous layer, and the back of the surface covering tile is a surface of the backing layer opposite the face layer. In one embodiment, the pressure sensitive adhesive is cooled rapidly immediately following application to raise a viscosity of the pressure sensitive adhesive and to inhibit migration of the pressure sensitive adhesive into the surface of the back.

Exemplary embodiments are directed to a method for applying an open pattern of pressure sensitive adhesive to a back of a surface covering tile. The open pattern of pressure sensitive adhesive is deposited on a release sheet, and the release sheet is placed on the back of the surface covering tile such that the pattern of pressure sensitive adhesive engages the back. The release sheet is placed onto the back, and the release sheet is removed from the surface covering tile while leaving the pattern of pressure sensitive adhesive on the surface covering tile. In one embodiment, the pressure sensitive adhesive covers less than about 40% of a surface area of the back.

### BRIEF DESCRIPTION OF THE DRAWINGS

The accompanying drawings, which are incorporated in and constitute a part of the specification, illustrate a plurality of embodiments and, together with the following descriptions, explain these embodiments.

FIG. 1 is a schematic illustration of a perspective view of an embodiment of the composite floorcovering with a patterned pressure sensitive adhesive layer;

FIG. 2 is a schematic illustration of a perspective view of another embodiment of the composite floorcovering with a patterned pressure sensitive adhesive layer;

FIG. 3 is a schematic illustration of a side view of an embodiment of the composite floorcovering having elements projecting from the back and engaging the pressure sensitive adhesive;

FIG. 4 is a schematic illustration of the back of an embodiment of the composite floorcovering containing a curvilinear pattern of pressure sensitive adhesive with the curved lines intersecting;

FIG. 5 is a schematic illustration of the back of another embodiment of the composite floorcovering containing a rectilinear pattern of pressure sensitive adhesive with the rectilinear lines crossed over in a plaid pattern;

FIG. 6 is a schematic illustration of the back of yet another embodiment of the composite floorcovering containing a pattern of pressure where the pressure sensitive pattern is not interconnected;

FIG. 7 is a schematic illustration of a side view of an embodiment of the composite floorcovering having areas between the pressure sensitive adhesive that are raised beyond the pressure sensitive adhesive pattern and compressible to facilitate planar adjustment during tile installation;

FIG. 8A is a schematic illustration of a side view of an embodiment of the composite floorcovering with a pressure sensitive adhesive pattern containing reinforcing elements;

FIG. 8B is a schematic illustration from the front face of an embodiment of the composite tile containing a pressure sensitive adhesive coated on a scrim applied to the back of the composite tile;

FIG. 9A is a schematic illustration of the back of an embodiment of the composite tile containing a plaid pattern of pressure sensitive adhesive having a heavier concentration of adhesive adjacent the cut edges;

FIG. 9B is a schematic illustration of the back of an embodiment of the composite tile containing pressure sensitive adhesive pattern of discrete shapes having a heavier concentration of adhesive adjacent the cut edges;

FIG. 10A is a schematic illustration of a cross section an embodiment of a felt backing needled from the side adjacent the face of the composite floorcovering to produce tufts on the back side to which a pattern of pressure sensitive adhesive is applied; and

FIG. 10B is a schematic illustration of a cross section of an embodiment of a composite floorcovering having a backing prepared as illustrated in FIG. 10A and receiving a face layer and a pressure sensitive adhesive pattern

### DETAILED DESCRIPTION

The following description of the embodiments refers to the accompanying figures. The same reference numbers in different figures identify the same or similar elements. Reference throughout the whole specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, particular features, structures or characteristics may be combined in any suitable manner in one or more embodiments.

Exemplary embodiments are directed to surface coverings and surface covering tiles having a face, a back opposite the face and a plurality of edges or sides extending between the face and the back. Suitable surface covering tiles include floorcovering tiles. Each edge intersects the face along a face cut edge and the back along a back cut edge. The surface covering tile has a thickness between the face and the back, and each edge spans the thickness. In one embodiment, the back is a porous surface. In one embodiment, the back is a porous fibrous felt. The back can be the needle entrance side of the felt or can be the side of the felt containing fiber tufts that are driven through the felt using a plurality of needles such as coarse needles. In one embodiment, the face is a fibrous material. The surface covering tile can be a single layer of material or can be multiple layers of material. For example, the surface covering tile can be a face layer placed over a backing layer. The face layer can be a fibrous layer, and the backing layer can be a felt.

Pressure sensitive adhesive (PSA) is disposed on at least a portion of the back. In one embodiment, the pressure sensitive adhesive is a material applied at high temperature and cooled rapidly. Suitable pressure sensitive adhesives include, but are not limited to, amorphous polyalphaolefin acrylic, tackified rubbers and block polymers. In one embodiment, the PSA is based on elastomers compounded with a suitable tackifier, e.g., a rosin ester. These elastomers can be based on acrylics, which can have sufficient tack on their own and do not require a tackifier. In one embodiment, the PSA is a biologically-based acrylate macromonomer grafted onto the backbone of an acrylate. The resulting PSA contains 60% bio-based materials. In one embodiment, the PSA is a hot-melt PSA containing butyl rubber, ethylene-vinyl acetate (EVA) with high vinyl acetate content. In one embodiment nitriles and silicone rubbers utilize special tackifiers based on “MO” silicate resins, which are composed of a monofunctional trimethyl silane (“M”) reacted with quadra-functional silicon tetrachloride (“Q”).

In one embodiment, the pressure sensitive adhesive is material suitable for application to the back a temperature from about 270° F. to about 370° F. In addition, the pressure sensitive adhesive has viscosity range of from about 8,000 centipoise to about 13,000 centipoise at 350° F. In one embodiment, the pressure sensitive adhesive has a thickness of from about 0.001 inches to about 0.100 inches.

In one embodiment, the pressure sensitive adhesive covers less than 40% of the back along each back cut edge. In one embodiment, the PSA covers only a portion of the back surface area of the back of the surface covering tile. The pressure sensitive adhesive covers less than about 25% of the back surface area. In one embodiment, the pressure sensitive adhesive is disposed on from about 20% to about 80% of the back surface area of the back of the surface covering tile. In one embodiment, the pressure sensitive adhesive covers about 40% of the back surface area. Therefore, about 20% to about 80% of the surface area of the back of the surface covering tile is open and does not contain any adhesive, and the PSA is arranged in an open pattern.

In one embodiment, instead of using an open pattern, the basis weight of the PSA is controlled to limit the amount of PSA applied to the surface covering tile. In one embodiment, at least one of the thickness, area weight, and weight profile of the pressure sensitive adhesive varies across the back surface. In one embodiment, the pressure sensitive adhesive has a first coverage density on the back on areas adjacent the edges and a second coverage density of on areas remote from edges. The first coverage density is greater than the second coverage density. This embodiment helps to hold the edges on the floor, countering a tendency of the edges to curl up at the seams between two adjacent tiles.

In one embodiment, the PSA adhesive is applied in a pattern containing a plurality of lines disposed across the back. In one embodiment each line has a width of from about 0.030 inches to about 0.200 inches wide. The pattern can contain a plurality of curvilinear lines or a plurality of rectilinear intersecting lines. In one embodiment, the pattern contains a plurality of discrete areas of pressure sensitive adhesive. The areas in the plurality of discrete areas are separate from each other, and the back contains pressure sensitive adhesive only in the discrete areas.

In one embodiment, the back has first areas containing the pressure sensitive adhesive and second areas separate from the first areas. The second areas are free of pressure sensitive adhesive. The surface covering tile has a first thickness between the face and the back in the first areas and a second thickness between the face and the back in the second areas. The second thickness is greater than the first thickness. The surface covering tile back is compressible in the second bare areas under pressure applied to the back and the face to decrease the second thickness, for example, to at least the first thickness.

In one embodiment, the pressure sensitive adhesive extends along the back to a plurality of discrete points along each back cut edge. A distance between any two points in the plurality of discrete points along a given back cut edge is less than twice the thickness of the tile, preferably less than about 1.5 times the thickness of the tile. In one embodiment, the surface covering tile also includes an open scrim attached to at least a portion of the back of the tile. The pressure sensitive adhesive is disposed on the scrim. In one embodiment, the surface covering tile includes a release sheet attached to and covering the pressure sensitive adhesive.

When the surface covering tile back is a felt, the PSA can be disposed on a needle-entrance or needle-exit surface corresponding to the back. Alternatively, the that back is a surface of the felt, and a plurality of fiber tufts extend from the back. The fiber tufts are created by needling the felt with widely spaced high-gauge needles. The pressure sensitive adhesive covers the fiber tufts, and the fiber tufts extend into the pressure sensitive adhesive.

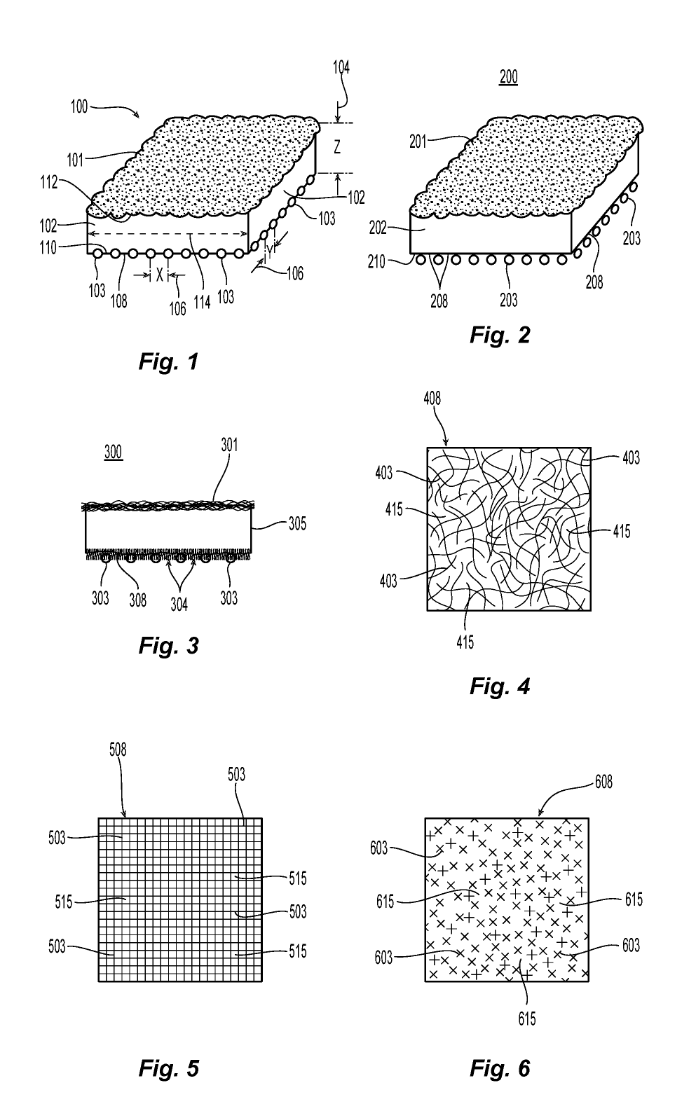

Referring initially to FIG. 1, an embodiment of a single-layer surface covering tile 100 is illustrated having a face 101 and a back 108 opposite the face. As an alternative to the single-layer surface covering tile, the surface covering tile can include two layers by attaching a separate backing layer to the face layer. For two layers, the back of the surface covering tile is the back surface of the separate backing layer. When the surface covering tile is applied to a surface to be covered, the back is placed adjacent the surface to be covered, and the face is exposed. A plurality of edges 102 or sides extend between the face and the back. The edges or sides define a tile thickness 104 between the face and the back. These edges can be rectilinear as shown or curvilinear. The plurality of edges can be parallel to each other or can intersect each other at various angles, resulting in any rectilinear or curvilinear variety of intermeshing shapes of tiles. The edges intersect the face along face cut edges 112 and intersect the back at back cut edges 110.

In one embodiment, the pressure sensitive adhesive extends along the back to each one of the back cut edges 110. In one embodiment, the pressure sensitive adhesive does not extend completely along each back cut edge. For example, the pressure sensitive adhesive extends along or covers less than 40% of the length 114 of a given back cut edge, i.e., the total length of the back cut edge covered by the pressure sensitive adhesive is less than about 40% of the overall length of the back cut edge.

In one embodiment, the pressure sensitive adhesive extends along the back to the plurality of edges or is located along the cut back edge at a plurality of discrete points 103. In addition, the distance 106 between any two points in the plurality of discrete points, including a first distance X between the points where the pattern of PSA ends at the edge in a first direction and a second distance Y where the pattern of PSA ends in a second direction perpendicular to the first direction, is less than twice the thickness 104 of the tile. Therefore, the PSA extends to the cut edges without being interrupted by a gap exceeding the thickness of the tile by a factor larger than 2, preferably not exceeding the thickness of the tile by a factor larger than 1.5. These patterns of PSA with the limitation on the spacing between discrete points of PSA along the cut edges ensure that relatively or sufficiently heavy PSA is present at the cut edges, and the use or application of an excessive overall level or amount of PSA on the back of the surface covering tile is eliminated. Reducing the overall amount, level or percentage of coverage of PSA avoids adverse effects on the breathability of surface covering tiles having porous materials such as carpet tiles.

Referring now to FIG. 2, another embodiment of a surface covering tile 200 is illustrated having a face 201 and a particularly porous back 208 opposite the face. The PSA is applied in a pattern to the back. In one embodiment, the patent of PSA is applied using methods suitable to prevent excessive flow of the adhesive and to limit penetration of the adhesive into the porous surface of the back. These methods for applying the pattern of PSA include, but are not limited to, the use of a polymer applied at a high temperature and rapidly cooled. Therefore, the PSA forms projections extending above the porous surface of the back.

As illustrated, the porous back 208 is relatively flat, and the pattern of PSA extends along the back of the tile and is located along the back cut edge 210 of the edges 202 of the tile at a plurality of discrete points 203. In one embodiment, the PSA penetrates through the back and into the backing layer to a limited degree. Consequently, in addition to limiting the overall weight of PSA, the limited depth of penetration of the PSA facilitates retention of most or all of the PSA to remain on the surface to be covered when the tile is removed.

Referring now to FIG. 3, another embodiment of a surface covering tile 300 having a face 301, a back 308 opposite the face and an edge 305 extending from the face to the back is illustrated. The surface covering tile includes a plurality of projecting elements 304 extending out from the surface covering tile along the back 308. These projecting elements include fibers and fiber tufts. The projecting elements extend into the PSA that is applied to the back of the surface covering tile and that extends to the back cut edge at a plurality of discrete points 303. In one embodiment, the projecting elements extend partially through the PSA. In another embodiment, the projecting elements extend completely through the PSA. By extending the projecting elements through the PSA, the PSA is anchored securely to the back and backing layer. Upon removal of the surface covering tile from the surface to be tiled, most or all of the anchored PSA is pulled from the surface and remains attached to the back of the surface covering tile. The result is an adhesive-free surface that is easily or readily prepared for the attachment of replacement tiles or for the application of alternative types of surface coverings.

Referring to FIG. 4, an embodiment of a back 408 of a surface covering tile is illustrated with a pattern of PSA formed by a plurality of curvilinear lines 403 of PSA applied to the back of the surface covering tile. The curvilinear lines are separated by a plurality of bare areas 415 that do not contain any adhesive. The plurality of discrete points are defined where the curvilinear lines intersect the back cut edge. The tile in the bare areas may have the same thickness as the areas containing the curvilinear lines, a lesser thickness or a greater thickness. The curvilinear lines can be systematically curvilinear, e.g., all having the same general shape, or randomly curvilinear. Therefore, the pattern of PSA can be a regular pattern or a random pattern. In one embodiment, the curvilinear lines are separated or spaced from each other. Alternatively, the curvilinear lines of PSA overlap or cross, as shown.

Referring to FIG. 5, an embodiment of a back 508 of a surface covering tile is illustrated containing a pattern of PSA formed by a plurality of rectilinear lines 503 of PSA applied to the back of the surface covering tile. The rectilinear lines are separated by a plurality of bare areas 515 that do not contain any adhesive. The plurality of discrete points are defined where the rectilinear lines intersect the back cut edge. The tile in the bare areas may be the same thickness as the areas containing the rectilinear lines, a lesser thickness or a greater thickness. The rectilinear lines can be parallel or can intersect in random patterns or in a regular pattern. In one embodiment, the rectilinear lines are parallel and spaced from each other. Alternatively, the rectilinear lines of PSA overlap or cross in a plaid or grid pattern, as shown.

Referring now to FIG. 6, an embodiment of a back 608 of a surface covering tile is illustrated with a pattern or PSA that is not interconnected, e.g., is not a pattern formed from interconnected curvilinear or rectilinear lines. The pattern of PSA can be formed from dots or random lines 603 of PSA or from shapes or other discrete areas of PSA applied to the back 608 of the tile. The pattern includes pressure sensitive adhesive only in the discrete areas, and the bare areas 615 between the discrete areas of adhesive do not contain any adhesive.

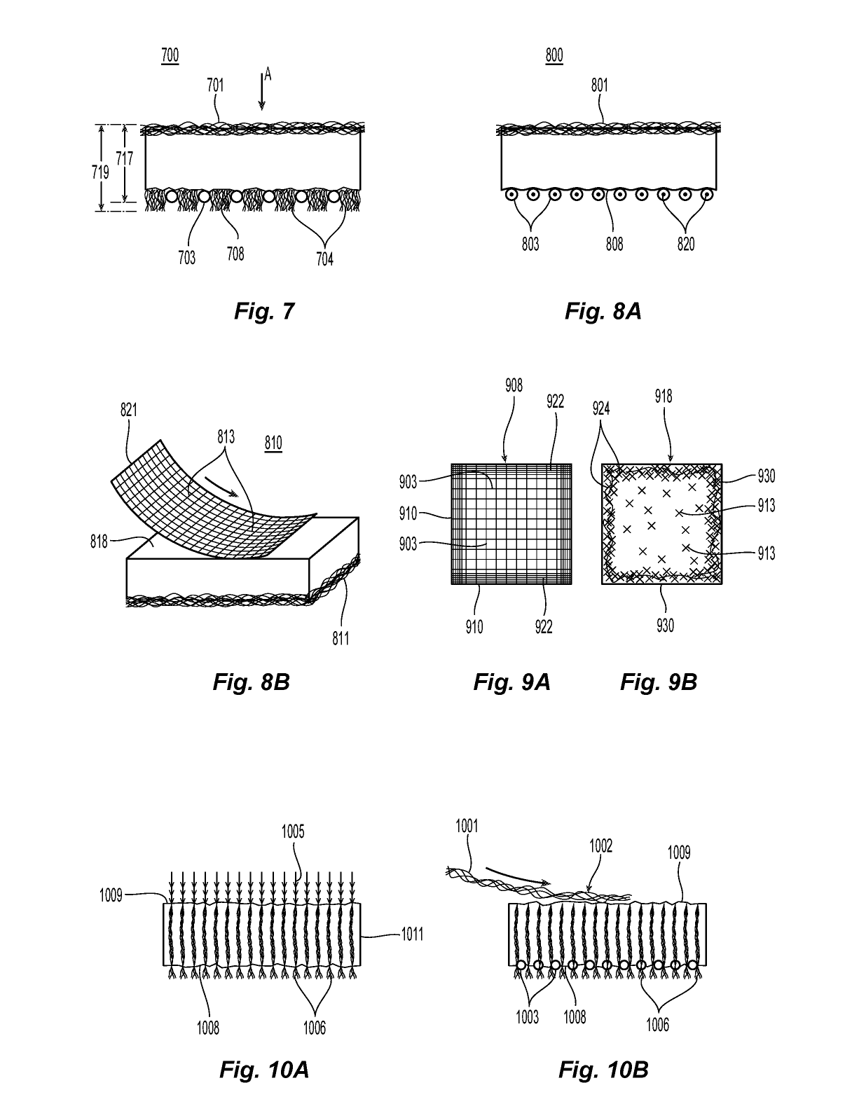

Referring now to FIG. 7, another embodiment of a surface covering tile 700 having a face 701 and a back 708 opposite the face is illustrated. This embodiment provides for the positioning of the surface covering tile over the surface to be covered while making adjustments to the exact positioning of the location of the tile before the PSA is engaged on the surface to be covered. Positioning of the surface covering tile without PSA surface engagement is provided by areas of the back containing the PSA having a lower profile than the surrounding areas that are free of PSA. These surrounding areas, however, are elastically compressible, enabling the handling and planar adjustment of the tile during installation and eventual affixing of the tile to the desired surface upon application of a compressing force to the face of the tile.

As illustrated, the back of the surface covering tile includes a plurality of adhesive areas 703 disposed across the surface area of the back and containing the pressure sensitive adhesive and a plurality of bare areas 704 separate from the adhesive areas. The surface covering tile has a first thickness 717 in the adhesive areas and a second thickness 719 in the bare areas. The second thickness is greater than the first thickness such that the bare areas engage the surface to be covered first before the adhesive areas. The back, in the bare areas, is compressible under a pressure applied to the face of the tile in a direction as indicated by arrow A. This decreases the second thickness and brings the PSA areas into contact with the surface to be covered, securing the tile to the surface to be covered.

Referring now to FIG. 8A, another embodiment of a surface covering tile 800 is illustrated having a face 801 and a back 808 opposite the face. The PSA 803 is applied to the back in accordance with any pattern or method described herein. Disposed within each area or line of PSA are one or more auxiliary or reinforcing elements 820. The reinforcing elements include, for example, fibers, fibrils or fabrics that help maintain one or more of the location, shape and thickness of the PSA. In one embodiment, fibers are coated with PSA, and the coated fibers are attached to the back of the surface covering tile in accordance with the desired pattern.

Referring now to FIG. 8B, another embodiment of a surface covering tile 810 is illustrated having a face 811 and a back 818 opposite the face. In accordance with this embodiment, the PSA is not applied directly to the back of the surface covering tile. The pattern of PSA 813 is applied to a separate open scrim 821. Preferably, the scrim is prepared with materials resisting expansion or contraction with variations of temperature or moisture or the application of force. In one embodiment, the scrim is coated with PSA. Alternatively, the scrim is embedded in PSA. The scrim containing the desired pattern of PSA is attached to the back of a tile. In one embodiment, the PSA-coated scrim does not cover the entire back of the surface covering tile. In one embodiment, the portions of the back of the surface covering tile containing the scrim have a lower profile than the surrounding areas, facilitating adjustments of the surface covering tile during the installation process. Suitable scrims include a woven fabric, an over-bonded fabric and a perforated nonwoven fabric. These fabrics can be prepared with reinforcing fibers or yarns, for example, carbon fibers or aramid fibers resisting expansion or contraction. Therefore, as an additional benefit, the scrim stabilizes the surface covering tile. In another embodiment, not shown, the pattern of PSA is deposited on a release sheet, and the release sheet is subsequently brought in contact with the back of the tile. In this embodiment, a scrim is not used.

In one embodiment, the pattern of PSA varies in at least one of thickness, concentration and density across the back of the surface covering tile. Referring to FIG. 9A, a pattern of PSA is applied to the back 908 of the surface covering tile. The pattern of PSA pattern contains a plurality of intersecting rectilinear lines 903 forming a plaid pattern or grid and having areas of heavier concentrations of PSA 922 adjacent the back cut edges 910. The heavier concentrations of PSA can be achieved by increasing the number of rectilinear lines in a given area or by increasing the size or thickness of each rectilinear line in the desired areas.

Referring to FIG. 9B, the PSA is applied to the back 918 of the tile as a pattern containing a plurality of discrete shapes 913 across the entire back of the surface covering tile. The pattern of PSA is applied to the back of the surface covering tile with areas of heavier concentrations of PSA 924 adjacent and along the back cut edges 930. In both embodiment, the concentration of PSA is lower in the middle or central area of the back of the tile. This arrangement helps secure the cut edges of the tiles and prevent the cut edges from raising away from the surface to be covered. In one embodiment the central area of the tile is free of PSA, and the pattern of PSA is interrupted along the back cut edges of the tile.

Referring now to FIG. 10A, in one embodiment, the surface covering tile is a felt 1011 having a back surface 1008 and a side opposite the back surface 1009. The felt is additionally needled on the side 1009 opposite the back using a plurality of coarse widely-spaced needles 1005. These needles produce a plurality of tufts 1006 extending out from the back 1008. The pattern of PSA is applied to the tufts, and the PSA can be anchored in the tufts, for example, as illustrated in FIG. 3. Alternately the PSA applied to the back surface has a lower profile than the surrounding tufts, for example, as illustrated in FIG. 7, to facilitate planar adjustment during installation of the tile, before being affixed to the surface to be covered.

Referring to FIG. 10B, in one embodiment, a separate face layer 1002 having a surface 1001 is attached to a felt layer 1011 prepared as described above with respect to FIG. 10A. The separate face layer is applied on the side opposite the back surface 1009. The pattern of PSA 1003 is applied to the back surface and some of the fibers within the tufts 1006 are contained within the PSA. This forms the surface covering tile containing PSA 1003. The separate face layer can be fibrous or non-fibrous, porous or solid.

In addition to surface covering tiles backed with PSA, exemplary embodiments are also directed to methods for making the surface covering tiles and attaching the surface covering tiles to a desired surface. Suitable methods for applying the PSA to the back of each tile include, but are not limited to, spraying, spraying and curing, printing including transfer printing directly to the back of the tile, and transfer printing onto a transfer sheet or release sheet that can then be pressed with heat or otherwise activated in contact with the tile or tile material.

The penetration of the PSA into the backing and the propensity to proceed into the backing are adjusted by controlling the conditions and patterns used to attach the PSA to the back. These conditions and patterns include, the viscosity of the applied PSA, the temperature of the PSA as applied, the geometry of the PSA pattern, the porosity of the back, the receptivity of the back to the PSA, the level of pressure used to apply the PSA, the absence of pressure in applying the PSA, the cooling rate used to set the PSA and combinations thereof. In one embodiment, the receptivity of the back is adjusted by needle-punching a felt backing layer. The needle-punched surface on the needle-entrance side is flat, with surface fibers that are rather tightly anchored and flat and suitable for applying the pattern of PSA onto the surface with high viscosity, followed by rapid cooling to achieve easier release from the tile and better recycleability of the tile. In another embodiment, high adhesion to the backing is secured and PSA residuals on the tiled surface upon eventual removal are avoided by using the fiber tufts emerging from the surface to anchor the PSA securely onto the backing. Suitable methods for forming distinct tufts that are particularly effective in anchoring PSA to the back are described in U.S. Patent Application Publication No. 2018/0014678 A1, which is incorporated by reference herein in its entirety. In these embodiments, widely-spaced coarse needles are used to drive distinct tufts of fibers through a felt.

In one embodiment, a method for creating a surface covering tile having a porous and recoverably compressible back applies a pressure sensitive adhesive to only a portion of a surface area of the back. In on embodiment, a plurality of nozzles are pressed into the back, and the pressure sensitive adhesive is injected onto the surface covering tile through the plurality of nozzles. A release sheet is applied to the back, and the surface covering tile is compressed to a uniform thickness across the surface area of the back. The release sheet is removed, allowing the surface covering tile to expand to create a first thickness in the surface covering tile in the portion of the surface are of the back containing the pressure sensitive adhesive and a second thickness in the surface covering tile outside the portion of the back containing the pressure sensitive adhesive. The second thickness is greater than the first thickness.

In one embodiment, the pressure sensitive adhesive is not applied directly to the back, but it is applied to a partially open scrim, for example, in the desired pattern of pressure sensitive adhesive. The partially open scrim containing the pattern of pressure sensitive adhesive is then applied to the back, for example, while applying the release sheet and compressing the surface covering tile. Suitable open scrims include, but are not limited to, a woven fabric, a knit fabric and a nonwoven fabric. In one embodiment, the open scrim contains aramid fibers, carbon fibers, yarns or combinations thereof.

In one embodiment, the surface covering tile is a single layer. Alternatively, a face layer is attached to a backing layer to create the surface covering tile. Suitable face layers include, but are not limited to, a fibrous layer, a non-fibrous layer, a solid layer and a porous layer. The back of the surface covering tile is a surface of the backing layer opposite the face layer.

An exemplary embodiment is directed to a method for applying an open pattern of pressure sensitive adhesive to a back of a surface covering tile. The open pattern of pressure sensitive adhesive is applied on a release sheet, and the release sheet is placed on the back of the surface covering tile such that the pattern of pressure sensitive adhesive engages the back. The release sheet is pressed onto the back and subsequently removed from the surface covering tile while leaving the pattern of pressure sensitive adhesive on the surface covering tile. In one embodiment, the pattern of pressure sensitive adhesive covers less than about 40% of a surface area of the back.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A surface covering tile comprising:
a face;
a back opposite the face;
a plurality of edges extending between the face and the back, each edge intersecting the back along a back cut edge; and
a pressure sensitive adhesive disposed on the back, the pressure sensitive adhesive covering less than 40% of the back along each back cut edge.

2. The surface covering tile of claim 1, wherein:
the tile comprises a thickness between the face and the back, each edge spanning the thickness;
the pressure sensitive adhesive extends along the back to the plurality of edges at a plurality of discrete points along each back cut edge; and
a distance between any two points in the plurality of discrete points along a given back cut edge is less than twice the thickness of the tile.

3. The surface covering tile of claim 2, wherein the distance between any two points in the plurality of discrete points is less than about 1.5 times the thickness of the tile.

4. The surface covering tile of claim 1, wherein the back comprises a porous surface.

5. The surface covering tile of claim 1 wherein:
the pressure sensitive adhesive forms a pattern across the back; and
the pattern comprises a plurality of curvilinear lines or a plurality of rectilinear intersecting lines.

6. The surface covering tile of claim 1 wherein:
the pressure sensitive adhesive forms a pattern across the back;
the pattern comprises a plurality of discrete areas of pressure sensitive adhesive, the plurality of discrete areas separate from each other; and
the back contains pressure sensitive adhesive only in the discrete areas.

7. The surface covering tile of claim 1 wherein:
the back comprises:
first areas containing the pressure sensitive adhesive; and
second areas separate from the first areas, the second areas free of pressure sensitive adhesive;
the surface covering tile comprises:
a first thickness between the face and the back in the first areas; and
a second thickness between the face and the back in the second areas, the second thickness greater than the first thickness; and
the surface covering tile is compressible in the second areas under pressure applied to the back and the face to decrease the second thickness.

8. The surface covering tile of claim 1, wherein the surface covering tile further comprises an open scrim attached to at least a portion of the back, the pressure sensitive adhesive disposed on the scrim.

9. The surface covering tile of claim 1, wherein the pressure sensitive adhesive comprises:
a first coverage density at locations adjacent the plurality of back cut edges; and
a second coverage density of pressure sensitive adhesive at locations remote from the plurality of back cut edges, the first coverage density greater than the second coverage density.

10. The surface covering tile of claim 1, wherein the pressure sensitive adhesive comprises amorphous polyalphaolefin acrylic.

11. The surface covering tile of claim 1, wherein the pressure sensitive adhesive is suitable for application to the back a temperature from about 270° F. to about 370° F. and has a viscosity range of from about 8,000 centipoise to about 13,000 centipoise at 350° F.

12. The surface covering tile of claim 1, wherein the pressure sensitive adhesive comprises a thickness of from about 0.001 inches to about 0.100 inches.

13. The surface covering tile of claim 1, wherein the pressure sensitive adhesive comprises a pattern containing a plurality of lines disposed across the back, each line comprising a width of from about 0.030 inches to about 0.200 inches.

14. The surface covering tile of claim 1, wherein at least one of a thickness of the pressure sensitive adhesive and a weight of the pressure sensitive varies across the back surface.

15. The surface covering tile of claim 1, wherein the surface covering tile comprises a release sheet attached to and covering the pressure sensitive adhesive.

16. The surface covering tile of claim 1, wherein:
the back comprises a back surface area; and
the pressure sensitive adhesive covers less than about 25% of the back surface area.

17. The surface covering tile of claim 1, wherein:
the surface covering tile comprises a felt;
the felt comprises a needle-exit surface; and
the back corresponds to the needle-exit surface.

18. The surface covering tile of claim 1, wherein:
the surface covering tile comprises a felt;
the felt comprises:
the back; and
a plurality of fiber tufts extending from the back and created by needling the felt with widely spaced high-gauge needles;
the pressure sensitive adhesive covers the fiber tufts; and
the fiber tufts extend into the pressure sensitive adhesive.

19. The surface covering tile of claim 1, wherein the back comprises a flattened, pre-calendered surface.

20. A method for creating a surface covering tile comprising a porous and recoverably compressible back, the method comprising:
applying a pressure sensitive adhesive to only a portion of a surface area of the back;
applying a release sheet to the back;
compressing the surface covering tile to a uniform thickness across the surface area of the back; and
removing the release sheet and allowing the surface covering tile to expand to create a first thickness in the surface covering tile in the portion of the back containing the pressure sensitive adhesive and a second thickness in the surface covering tile outside the portion of the back containing the pressure sensitive adhesive, the second thickness greater than the first thickness.

21. The method of claim 20, wherein:
applying the pressure sensitive adhesive comprises applying the pressure sensitive adhesive to a partially open scrim; and
the method further comprises applying the partially open scrim to the back while applying the release sheet and compressing the surface covering tile.

22. The method of claim 21, wherein the open scrim comprises a woven fabric, a knit fabric or nonwoven fabric.

23. The method of claim 22, wherein the open scrim comprises aramid fibers, carbon fibers or yarns.

24. The method of claim 20, wherein applying the pressure sensitive adhesive further comprises:
pressing a plurality of nozzles into the back; and
injecting the pressure sensitive adhesive onto the surface covering tile through the plurality of nozzles.

25. The method of claim 20, wherein the method further comprises attaching a face layer to a backing layer to create the surface covering tile, the face layer comprising a fibrous layer, a non-fibrous layer, a solid layer or a porous layer and the back of the surface covering tile comprising a surface of the backing layer opposite the face layer.

26. The method of claim 20, wherein the method further comprises cooling the pressure sensitive adhesive rapidly immediately following application to raise a viscosity of the pressure sensitive adhesive and to inhibit migration of the pressure sensitive adhesive into the surface of the back.

27. A method for applying an open pattern of pressure sensitive adhesive to a back of a surface covering tile, the method comprising:
depositing the open pattern of pressure sensitive adhesive on a release sheet;
placing the release sheet on the back of the surface covering tile such that the pattern of pressure sensitive adhesive engages the back;
pressing the release sheet onto the back; and
removing the release sheet from the surface covering tile while leaving the pattern of pressure sensitive adhesive on the surface covering tile.

28. The method of claim 27, wherein pressure sensitive adhesive covers less than about 40% of a surface area of the back.
